(19) United States
(12) Patent Application Publication
(10) Pub. No.: US 2018/0021215 A1
(43) Pub. Date: Jan. 25, 2018

(54) Method of Treating PTSD and other anxiety-related disorders.

(71) Applicant: Gary Sinclair, Escondido, CA (US)

(72) Inventor: Gary Sinclair, Escondido, CA (US)

(21) Appl. No.: 15/657,170

(22) Filed: Jul. 23, 2017

Related U.S. Application Data
(63) Continuation of application No. 62/366,071, filed on Jul. 24, 2016.

(51) Int. Cl. A61H 23/06

(52) U.S. Cl. CPC A61H 23/06; A61H 2201/1635

(57) ABSTRACT

This invention is directed toward a method of neutralizing a past hurtful or anxiety-provoking memory using the practitioner's hands in a variety of steps to apply pressure and movement to the hand and wrist of a patient or upon the practitioner himself or herself, utilizing the method.

### CROSS REFERENCE TO RELATED APPLICATIONS

This application claims priority back to U.S. Provisional Application No. 62/366,071, filed Jul. 24, 2016, a copy of which is included in this application and the contents of which are incorporated by reference into this application.

### STATEMENT REGARDING FEDERALLY SPONSORED RESEARCH OR DEVELOPMENT

This invention was not federally sponsored.

### INVENTOR

Gary Sinclair, resident of Escondido, Calif., citizen of United States.

### BACKGROUND OF THE INVENTION

### Field of the invention

This invention relates to the general field of using hands fingers to treat anxiety-related memories and disorders, and more specifically to a method of using hands and fingers to apply pressure to certain pressure points on a patient's hand and wrist to neutralize an unpleasant memory.

History of the invention's industry. Stress- and anxiety-related problems are becoming more and more widely recognized as serious health issues. As scientific research focusses more on a person's mental health, it is becoming more and more apparent that negative memories from the past play a major role in everything from weight gain to the likelihood that a person will commit suicide. Thus, there is a long-felt need for a method by which these negative memories can be neutralized.

### Prior Art

There have been attempts to address this issue in the past, including several patents and patent applications that try to treat this issues through acupuncture (CN 106377420 to Hohai University), psychological massage (CN 103489145 to Jining University), and therapeutic technologies (US20100159427 to Bachar and IN 20150038411 to Bansal Sunita Pant). None of these methods and methodologies, however, provide a self-treating program that can remove negative thoughts. There is also prior art in the field of motor training of fingers and other parts of the body, such as CN105664446 to Sir Run Run Shaw Hospital, CN 10376402 to Nanyang Technological University, CN 203943869 to University of Nanjing Chinese Medicine, and CN 105214195 to Evik Technology. None of these programs, however, provide a repeatable method that works with all individuals. Thus there has existed a long-felt need for a program that allows a person to neutralize negative emotions that can be performed with regular success on a variety of patients, where the method can be performed on one's self or on another person.

The current invention provides just such a solution by teaching a series of steps that a practitioner can take in using his or her fingers to help a patient neutralize a negative memory. The process can be done by a practitioner of the method on either himself/herself or another person.

### OBJECTS OF THE INVENTION

It is therefore an object of the present invention to provide an effective, teachable method by which a patient's negative memories can be neutralized.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings. Since the invention is a method of treatment, it is important to note the differences in the hand positions from step to step.

FIGS. 1 through 21 are a series of photographs of a practitioner using, in this case, his hands, to provide a treatment. FIGS. 1 through 8 show the practitioner treating himself or herself; FIGS. 9 through 21 show the practitioner treating another person.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The FIGURES are a series of drawings showing a practitioner using, in this case, his hands to treat, in this case, himself. It should be noted that accomplished practitioners of this method can also use it on others, as illustrated in

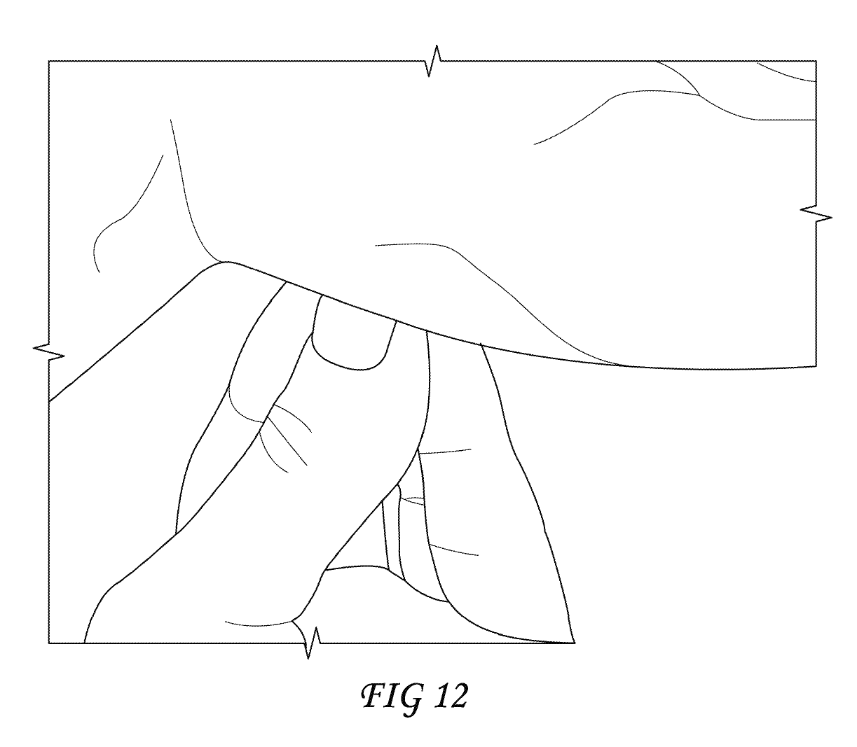

FIG. 12 and on. In terms of preparing to effect a treatment on himself or herself, the practioner uses both hands in this procedure. The procedure uses the palm and fingers of the right hand on the back side of the left hand. The practitioner's hands should be in a loose and rounded-looking position, and must remain so until the procedure is completed.

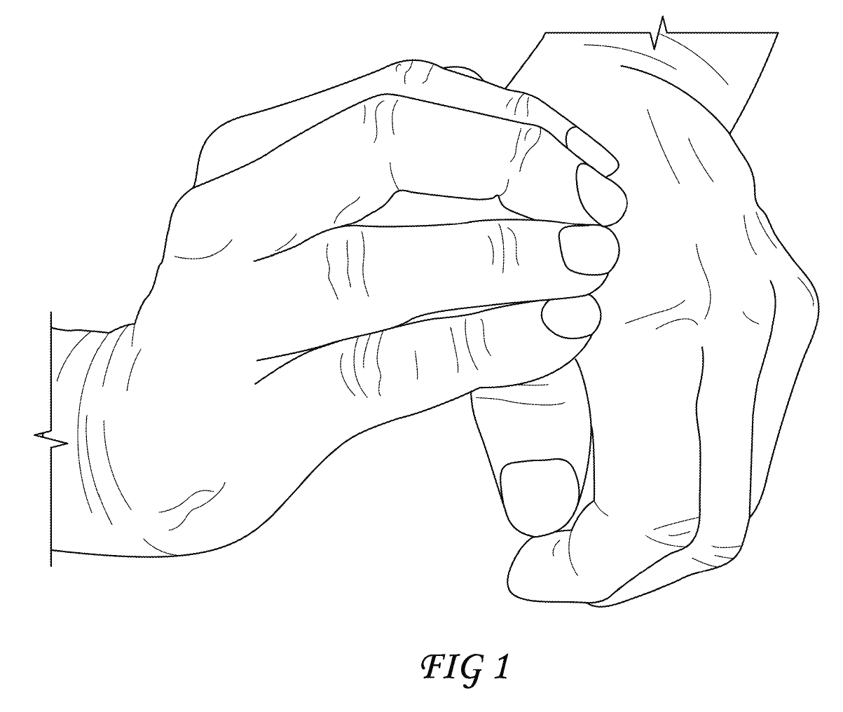

FIG. 1 shows Step One where the practitioner is treating himself or herself: Practitioners relax the right hand and place the right hand's finger tips up against their curved and relaxed left hand. The fingers of their left hand will be pointed more out to the side so that they are looking straight across the center line of knuckles. Practitioners then allow their right hand to relax so that their right hand fingers make physical contact with the side of the thumb of their left hand. This thumb position helps keep their hands in the relaxed fingers position. As they do this, their little finger will be aimed straight at the row of knuckles connecting the fingers of their left hand. This location is the beginning point of contact for each repeated round in the process. Their little finger will always start up against the pointer finger center knuckle of each associated hand. To better visualize this, one can think of the line of knuckles as the dividing line in this work, with an intention that all of the center hand knuckles get rubbed across twice as the practitioner proceeds. They are going to be completely covered and rubbed on the way over, and as later directed, completely covered and rubbed on the way back.

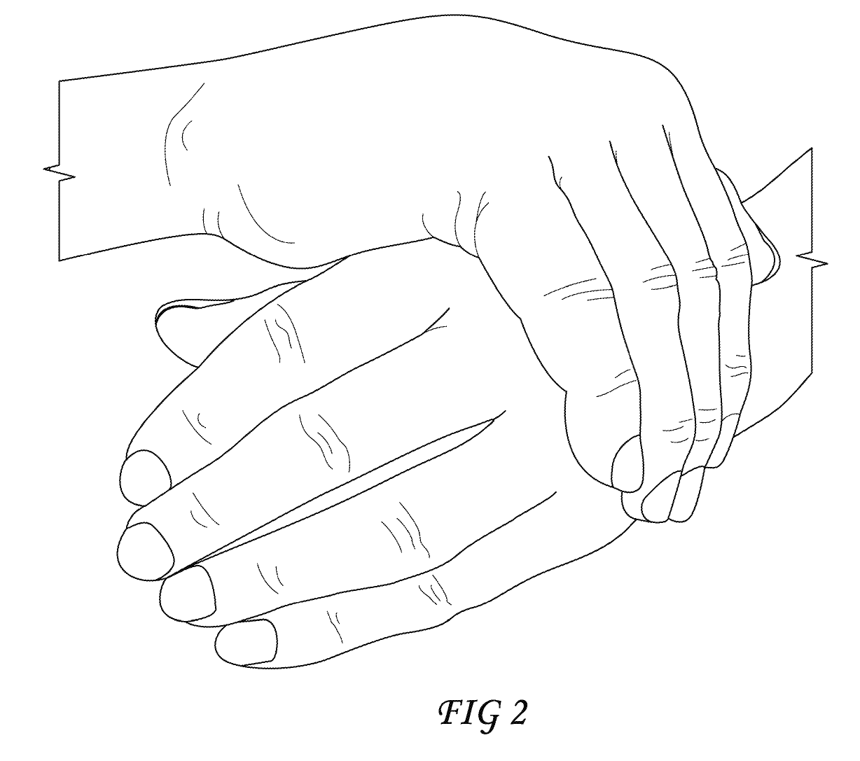

FIG. 2 shows Step Two: Once they have both hands relaxed, with both thumbs pressed up against their fingers in a curvature position, the practitioners begin to slide the fingers of the right hand up, over and across the wrist area of the left hand, following the line of the knuckles, with an intention to rub and feel all the palm-to-wrist connection. They do this glide while keeping their left hand still. As they do this, note their little finger intentionally glides over the complete first row of big knuckles connecting their fingers. Their right thumb will glide close to where the wrist connects to the arm. Both hands are to make as much skin-to-skin surface contact as possible.

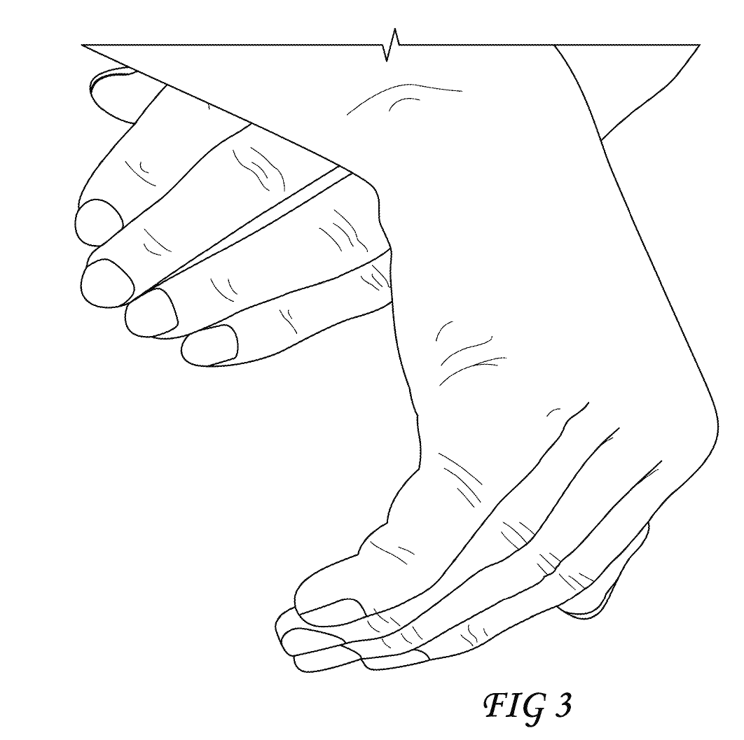

FIG. 3 shows Step Three: Allow both hands to feel all the contact of the palm of their right hand to the left top wrist as they slide their rubbing hand across the top of their left hand. Stop when they are just past the full back of the wrist area of the left hand and front of the palm area on their right hand. The underside of their right arm will be resting on the top of the left hand. They will feel like they could drop their right hand down at the wrist joint over the left hands outside edge. It is not necessary to drop the hand down, however, no part of either wrist or fingers area is currently touching that area of the opposite hand.

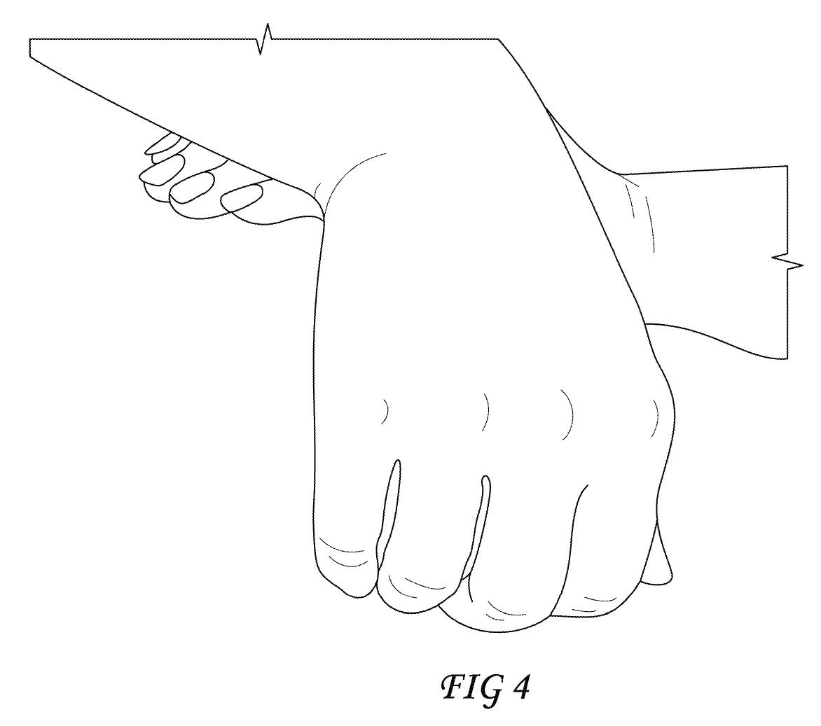

FIG. 4 shows Step Four: Slide the front of their right arm down toward their fingertips until they overlay all the fingers of the left hand with their underside right arm. Their right hand palm and fingers still extend relaxed out beyond the fingers of the left hand. The practitioner stops when their right hand is in a position where when they do pull their hand back across, the thumb glides directly over the top of the knuckles connecting the fingers like the little finger did before.

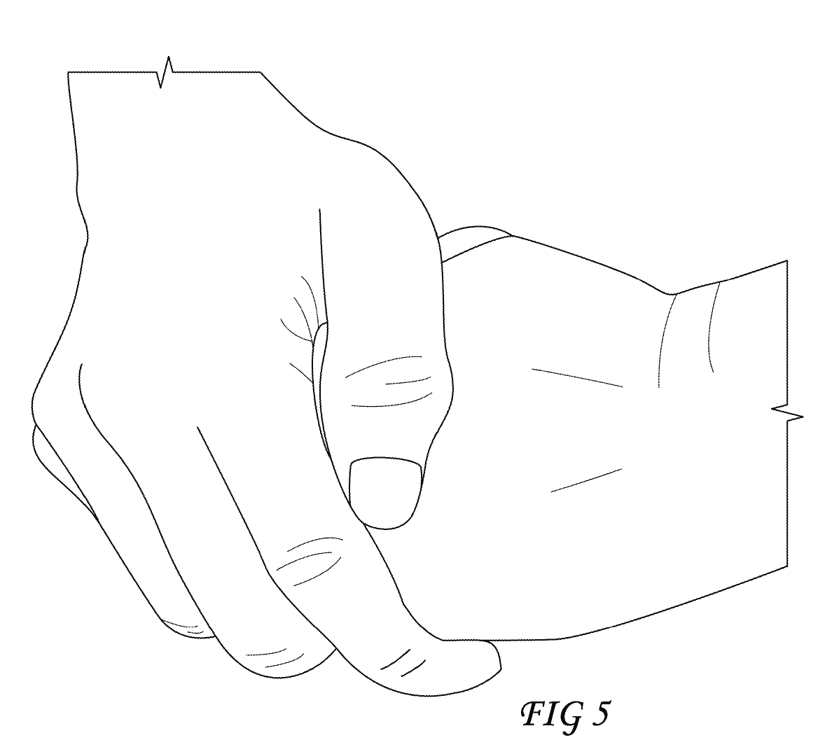

FIG. 5 shows Step Five: The practitioners begin to glide the contact surface of their right palm side back across the knuckles and joints of all the fingers and ultimately to cover the thumb of their left hand. Their palm and fingers will come all the way until the fingertips are once more at the edge of the left hand and slightly down from where they started. While that is happening, the palm and fingers of their right hand are rubbing all the fingers and knuckles of their left hand. Their thumb again covers all the knuckles beyond the wrist like their little finger did earlier. When they finish coming all the way back, they slide their right hand little fingertip back to the starting position.

Both hands must stay relaxed in the complete process for the best results. Straightening their fingers changes the participation of energy centers they are using. The practitioner feels the feeling of their thumb making contact just like all the other area of the wrist and fingers.

At this point they have essentially traced a path in a clockwise direction with their right hand over their left hand that resembles the shape of an oblong box as they go across, slide down, and come back across, and then move back to the starting position. The practitioners do this process until it is a fluid continuous movement with four full complete passes.

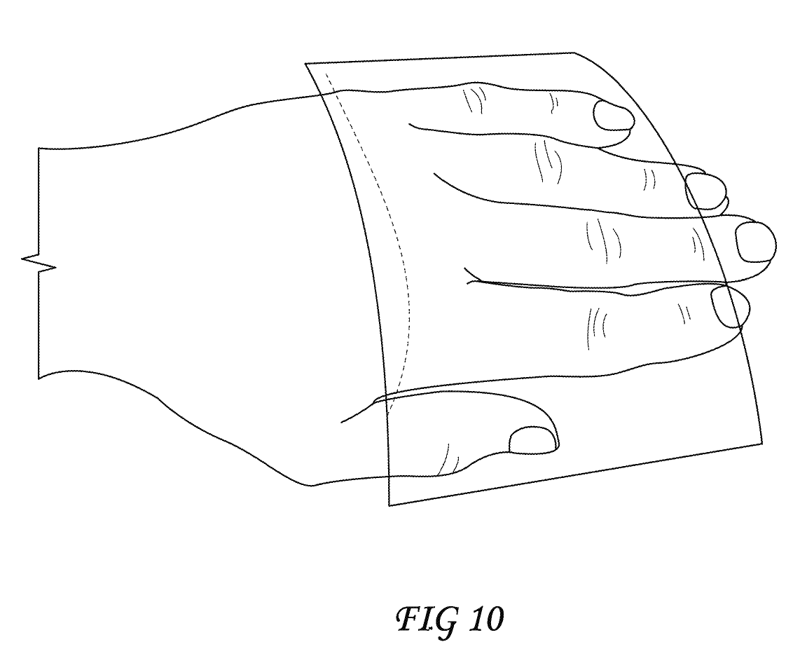

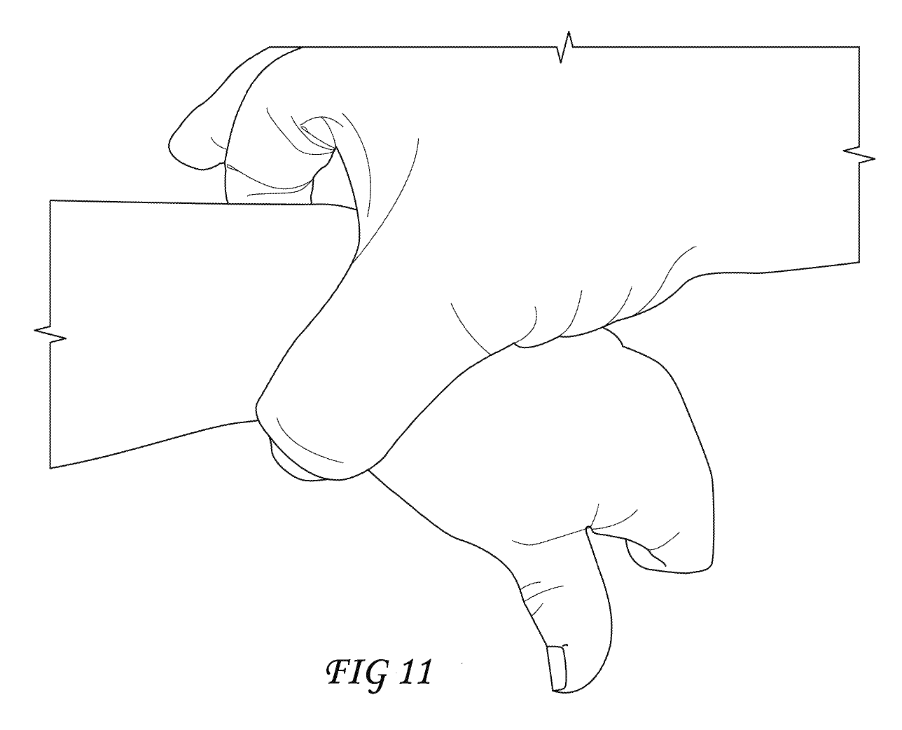

The practitioners test the area of coverage in both directions by placing their little finger in the curved hand position without moving it, directly on top of the row of knuckles. As they see their fingers there on top, note that they are basically covering all the top of the left wrist. [See FIG. 10] Next they switch to the second crossing path location by placing their thumb on the top of the row of knuckles. If their thumb is directly on top of that row of knuckles, then they can note that all of the other knuckles on their left hand are now completely covered by the fingers on their right. [See FIG. 11] This allows for the opening and use of all the energy meridians in their body. It is important that this coverage be there. Clients will have a tendency to roll their fingers under or only be rubbing near the knuckles only. If the right hand finger tips are slightly elevated and not touching, this diminishes the end result potentiality and they may become the one who says they still have emotions and feelings related to the memory they are treating as the entire energy field is not participating in neutralization.

Done correctly, this method has always produced 100% results. The inventor has mentioned using NO memory at this point in time as it is all about learning the process.

it is important to remember that the practitioners do not move their left hand while learning the process. It should initially remain steady while their right hand does the clockwise pattern movement.

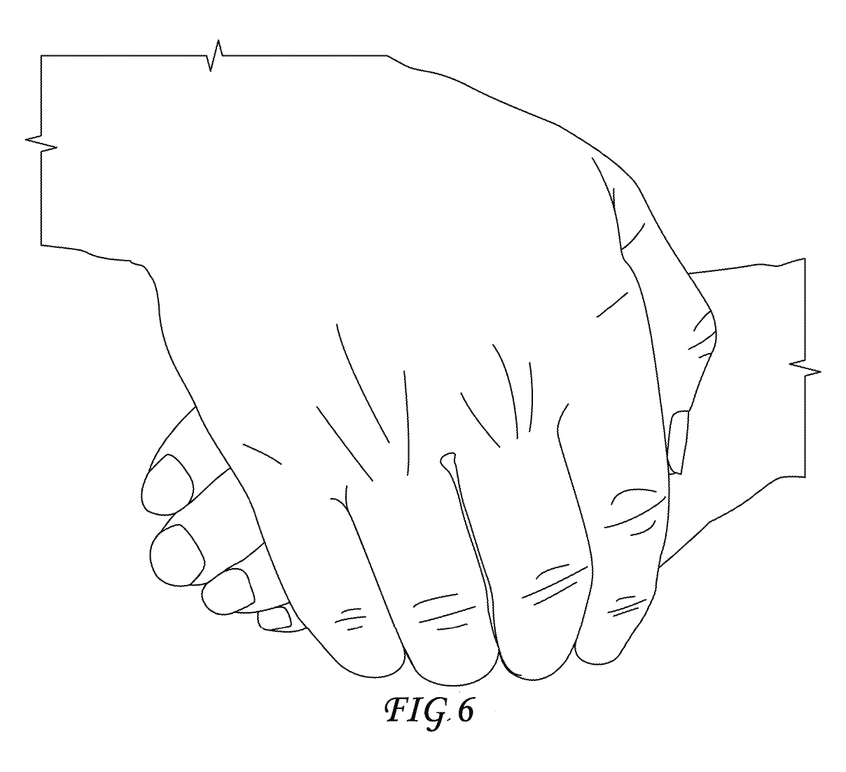

FIG. 6 shows Step 6. Everything from here is now a repeat of these steps as they slide their fingers back to the starting position. From here they repeat the process for a total of four passes until they make it feel like one continuous motion, and realize, with their eyes closed, they seem to be able to do it automatically, as they notice all the feelings associated. One thing they will begin to notice is how relaxed they will become as they are actually smoothly balancing their energy into a very peaceful state of being while doing this without thinking about a memory.

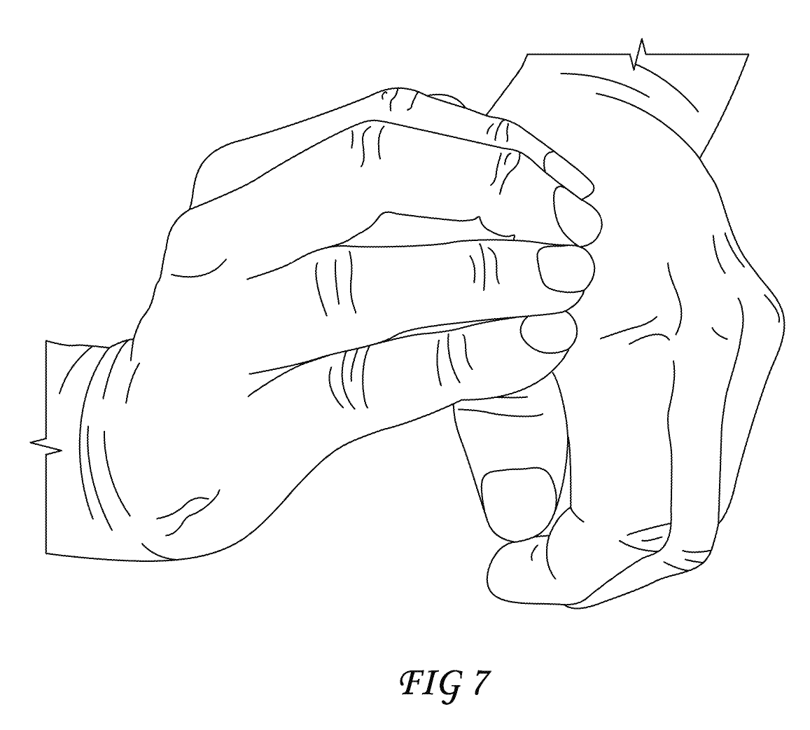

FIG. 7 shows Step 7: Now if the practitioners put a mirror between their hands and they were ready to do the next step, they would merely repeat it on the right hand doing the reverse direction of their slide and glide pattern. On the left hand they went in a clockwise direction on the top of the hand making four complete patterns. On the right hand top, they will go in a counter-clockwise direction. Practice until they can do four more complete patterns almost without thinking.

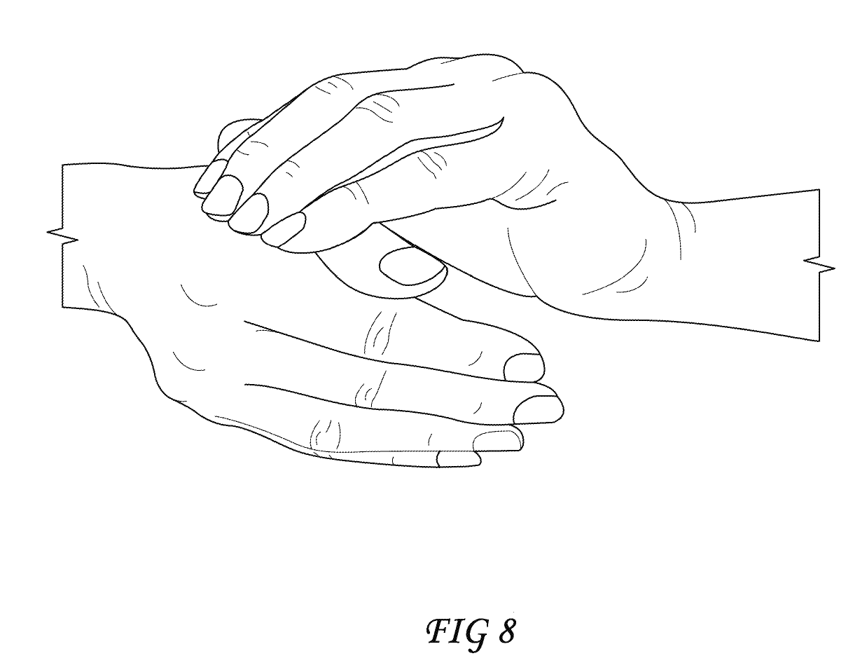

FIG. 8 shows Step 8: Place their relaxed left hand's finger tips up against their curved and relaxed right hand. The fingers of their right hand will be pointed more out to the side so that they are looking straight across the center line of knuckles. Allow the left hand to relax so that their left hand fingers make physical contact with the side of the thumb of their right hand. As they do this, their little finger will be aimed straight at the row of knuckles connecting the fingers of their right hand. This location is the beginning point of contact for each repeated round in the process on their right hand.

Once they have both hands relaxed in the curvature of the initial ball holding position, begin to slide the fingers of the left hand up, over and across the wrist area of the right hand, following the line of the knuckles, with an intention to rub and feel all the palm-to-wrist connection. Do this glide while keeping their right hand still. As they do this, note their little finger intentionally glides over the complete first row of big knuckles connecting their fingers. Their right thumb will glide close to where the wrist connects to the arm. Both hands are to make as much skin-to-skin surface contact as possible.

From here they continue doing exactly what they did on the back of their left hand with their right hand until they have completed the full process in the exact same continued pattern as they did on their left hand and come back to the starting position.

It is important that practitioners remember that they do not move their right hand while learning the process. It should initially remain steady while their left hand does the counter-clockwise pattern movement.

Once they have accomplished what seems to be an effortless memorized process, start checking how long it takes they to do both sides with four passes on each hand. In the beginning their goal was just one continuous process so that they could make this method work.

It should take they approximately twenty seconds to complete, ideally, doing four full, this method teaches that a practitioner passes on the top of both hands. It is however not about the speed; it is about the contact and the feeling of making contact happen naturally and automatically. The less they have to think about what they are doing, the greater their results of neutralizing will be. It should be noted, however, that depending on the patient, the severity of the memories that are to be neutralized, and the experience of the practitioner, the process may sometimes be more effective when five or six repetitions are done, and in some cases it is contemplated that up to 50 passes may be made.

Using this method to Neutralize a Memory

The areas associated and covered in this process are outlined below.

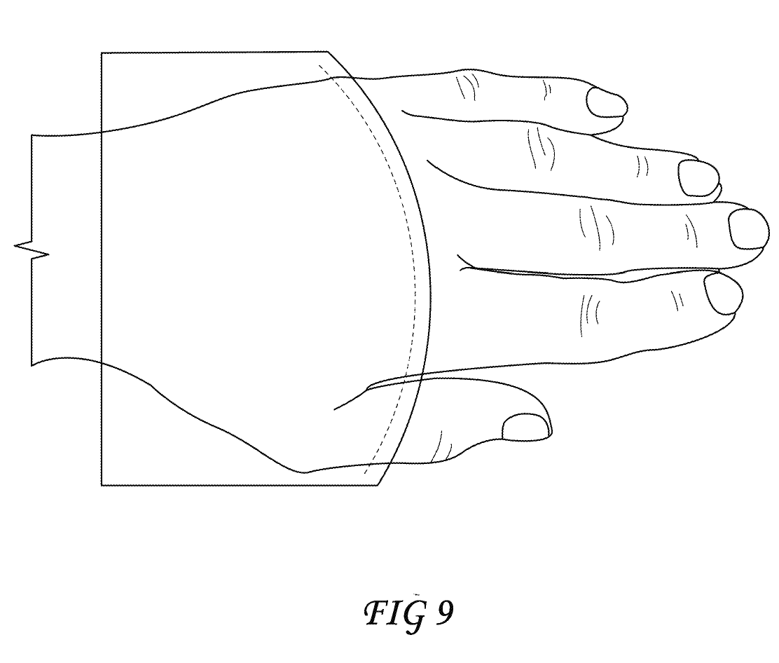

FIG. 9 shows the use of the invention on another person. Looking at the back of the left hand they can see the solid black line outline of the area of rubbing coverage by the right hand on the back of the top left hand. The line of knuckles with the dotted line is the area of gliding on and over coverage from the pointer finger knuckle to past the little finger knuckle. The little finger of the right hand makes contact with all the knuckles as they push their hand forward making sure that all the area inside the solid line are connected in contact with the fingers and palm of their right hand. They glide until their arm just behind the wrist is now on top of the area of coverage. NOTE: It will be the reverse image when done on top of the right hand.

FIG. 10 shows the next step. Looking at the back of the left hand they can see the solid black line outline of the area of rubbing coverage over the knuckles and fingers by the right hand on the back of the top left hand. The line of knuckles with the dotted line is the area of gliding on and over coverage from the little finger knuckle to past the pointer finger knuckle. The thumb of the right hand makes contact with all the knuckles as they pull their hand backwards making sure that all the area inside the solid line is connected in contact with the palm and fingers of their right hand. They glide until they have come to the side of the hand and then move back to starting position. NOTE: It will be the reverse image when done on top of the right hand.

Think about scaling all memories on a 1 to 10 with 10 being the worst, then a 1 would be a memory that is hardly there at all. A memory in the 9 to 10 range could be classified as worst memory ever or a post-traumatic stress disorder,

PTSD memory. Most people when they think of memories at that 9 to 10 level realize they are memories that made them make changes to their lives. For some people those changes were major, all the way to seemingly putting life on hold.

For the initial run of this process, pick a memory with a negative charge in the 3 to 5 intensity range. Do stay with the learning experience and let it prove itself to be that great gift that this method is in the end.

As they think about this memory, have some fun and play it in their head so that they can learn everything they can about it. Notice the sharpness, clarity, words, sounds, and feelings. What can they distinguish so that when they play it again later, they can check for differences? This will help with the quality of their first experience with Soul Link™. Again, they can do a comparative of what is there now with what remains. For many the actual characteristic representations or submodalities will change, even at this level of memory. So, what can they distinguish about the sharpness, clarity, words, sounds, and feelings? Do all that they can so that they will seek to be able to remember this memory as they now perceive it.

When they have learned all they can about this memory, they place their right hand fingers against their left hand where they know the little finger is in line with the top knuckles. Now turn their focus as much as possible on all they recall as they repeat this memory in their mind's eye while completing four passes of this method on each hand. Remember to do four full passes on both hands.

The key component at this time is focusing their attention on the memory and not on how to move their hands. All hand movement should be close to automatic for best results. If they really have to focus on moving their hands, then they best stop what they are doing and practice it again until they feel they can do it automatically with their eyes shut.

When they are done, allow their self to stop thinking about what they were doing and simply look around and internally tell their self some of the things they see. Like before, this step allows they to stop thinking about the memory they were working on. Continuing to remember the memory is like sitting at an old-fashioned switch board where all the cords are connected to their thinking from the time they start. By looking around they are basically pulling out the old cords of attention and connecting in new ones.

The practitioner then goes ahead and checks what has happened to the emotions and feelings that caused they to choose this memory in the first place. Is there anything there now? If there seems to be something there, check to see if it is the same memory or another in the line of gestalt that is coming up as a connection. If there is anything there remaining as a negative, run the full pattern again as they pay attention to the emotions and feelings that now arise. Otherwise, try to note any changes that they can find to determine if this memory is still there and intact and what the differences are from the way they remembered it before. Some will have a harder time finding the memory, and for some it may seem gone even at this level.

With a three to five level memory, it is not common for there to be residual that remains unless they paid more attention to the touch process than the memory content.

Give their self another educational test using another memory in the 5 to 8 range.

When the practitioner started working with memories they were scaled on a 1 to 10. For some people 8 and up, in their thinking, can be what each person would call our worst memory ever. We have no way of knowing that in advance so I am always careful in making sure that a memory in the 9-10 range is the last one that I offer in a training.

The practitioner then goes ahead and does that which they would call their worst memory ever now. Find those emotions and feelings that have empowered this memory to be what it is; notice the detail of the memory; take a deep breath; now use this method on those emotions and feelings.

Next, the practitioner checks, are the emotions and feelings gone? Can they even still remember the memory? From the inventor's experience, he can tell they that with PTSD and worst memory ever, for 20% of the people, when that memory is detrimental to the ongoing health of that client, they may not be able to completely find it again. For some, although it seemed in their face, it is now over there somewhere and they realize it no longer bothers them. So, what about they?

Was there a point where they realized the memory was starting or even completed changing?

Short Check List for proper utilization of this method.
1. Find a negative memory in appropriate range
2. Do the method with four passes on each hand
3. Look around to break the mental connection
4. Memory should be neutral

Learning to do the method on Others

The process to perform the method on others is still done on the hands with the same area of coverage.

Step One: Make sure the practitioner has asked permission to touch their hands.

Step Two: Ask the client to become aware of the memory they wish to neutralize. It is not necessary for the client to tell they the memory; in fact it is preferred if they do not verbalize the memory and that they keep the session content-free as much as possible.

Step Three: Tell them that their only job is to pay attention completely to that memory while they use their hands to connect the energy fields in their body with what they are holding in mind to neutralize as the memory. Tell them to give no attention to what they are doing with their hands, only to work hard at maintaining their focus on the memory (and the emotions and feelings it brings forward). It may help with concentration if they close their eyes rather than watch what they are doing.

Step Four: Always start with the top of the left hand being rubbed. If they wonder which hand to do first, always do the top of the one that is left.

The Process on Others

FIG. 11 Shows Step One of actually touching the patient: With they right hand, pick up their left arm by grasping it and lifting it into position at the wrist with their thumb and first pointer finger.

FIG. 12 shows Step Two: As they lift their hand, place their left hand thumb and fingers into a pointed cone position pointed upwards directly under the center core against their left hand palm area. This is a support position.

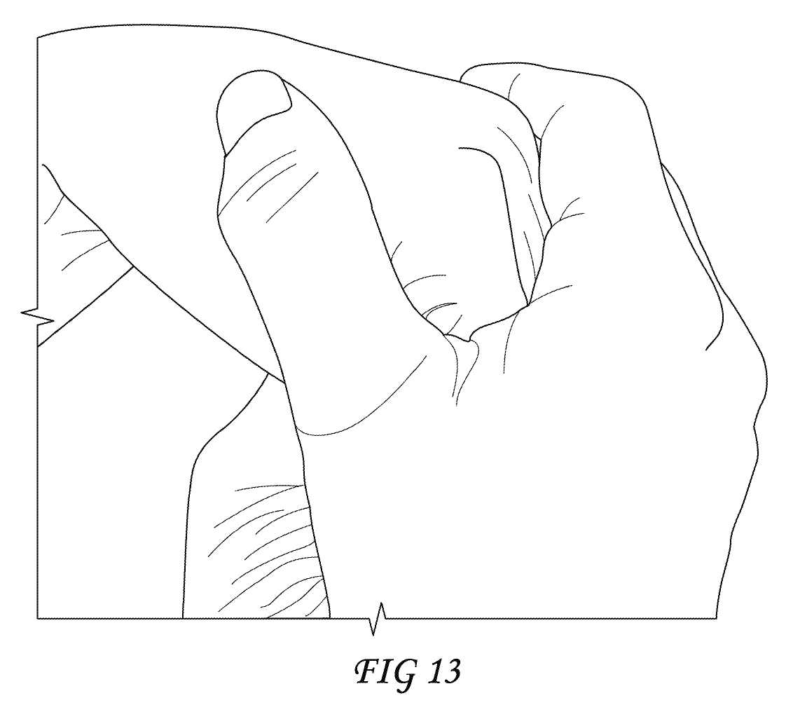

FIG. 13 shows Step Three: Place their right hand on top of their left wrist and simply slide it to the right towards the finger tips as they say to them, “Just relax their hand and allow me to do what I do to connect all their energy while their only job is to simply focus on the memory they wish to neutralize.” In this way, they relax their fingers and they reiterate all that they are now responsible to do to fully participate is to relax and focus on the memory, emotions and feelings.

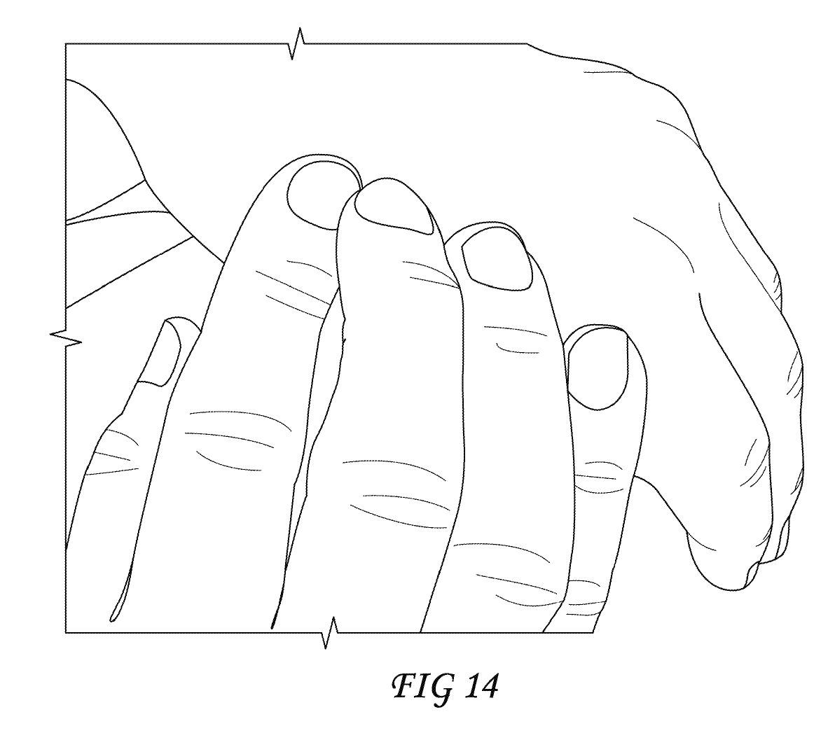

FIG. 14 shows Step Four: Place their relaxed right hand little finger-tip up against their curved and relaxed left hand. Their thumb will be up against the pointer finger center knuckle to help they hold that relaxed position. Their little finger will be aimed straight at the row of knuckles connecting the fingers on the top middle of their left hand.

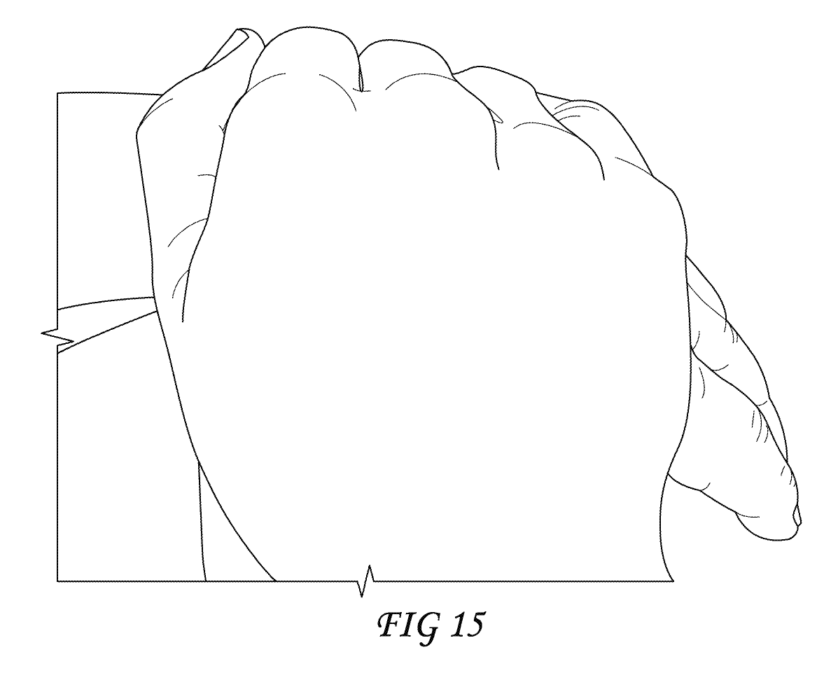

FIG. 15 shows Step Five: Slide their fingers and wrist of their right hand over and rubbing against the wrist area of their left hand following the line of the knuckles connecting their fingers with an intention to rub all the feeling area of their left wrist. As they do this, note their little finger intentionally glides over the complete first row of big knuckles. Their right thumb will glide close to where the wrist connects to the arm. Both hands are to make as much skin-to-skin surface rubbing contact as possible.

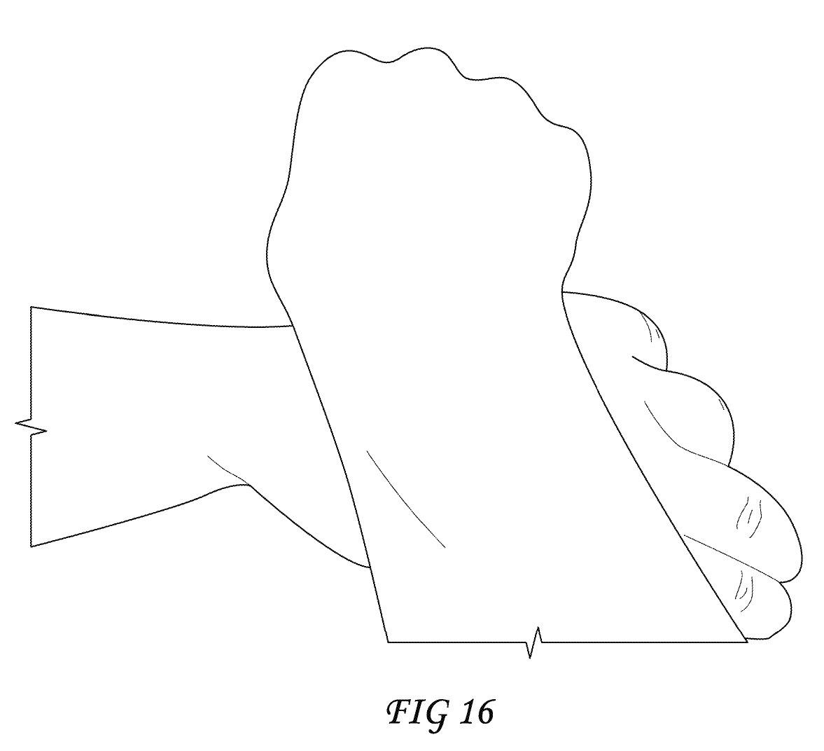

FIG. 16 shows Step Six: Allow the skin on the front of their right hand to feel the gliding contact of their fingers and palm on their left hand as they slide their rubbing right hand across. Stop when they are just past their full hand and palm area. The bottom side of their right arm will be resting on the top of their left hand wrist. They will feel like they could drop their right hand down over their left hands outside edge, however, dropping the hand is not necessary.

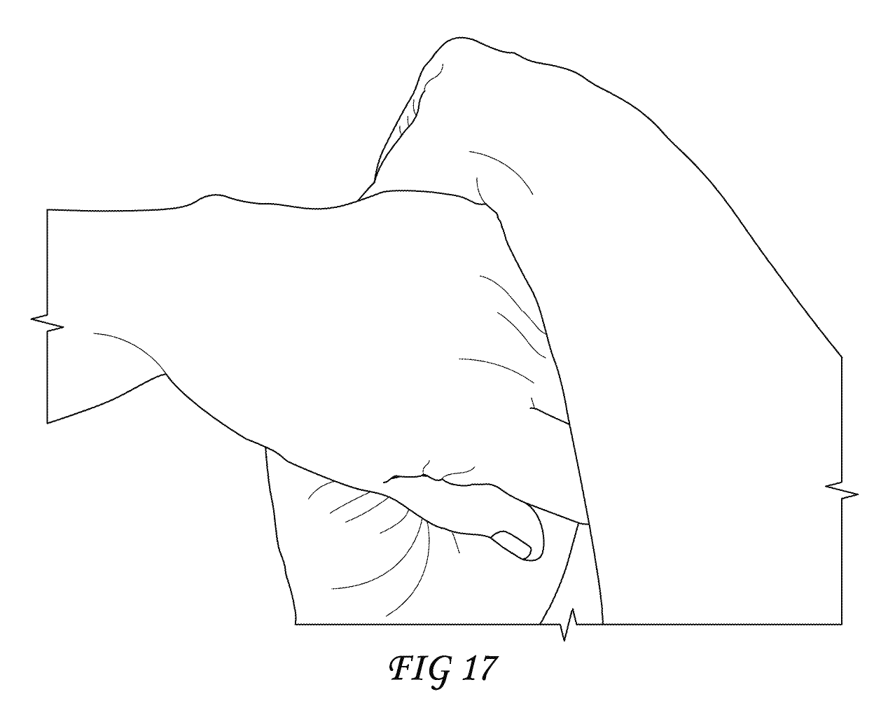

FIG. 17 shows Step Seven: Slide the backside of their right arm down toward their left hand fingertips until they overlay all the fingers of their left hand with their underside right arm. Their right hand palm and fingers still extend out beyond the fingers of their left hand. Stop when their right arm is in a position where, when they pull their right hand back across, the thumb will glide directly over the top of the knuckles just beyond the wrist like the little finger did before. Keep their thumb up against their fingers as they ensure both hands stay relaxed with no fingers straightened.

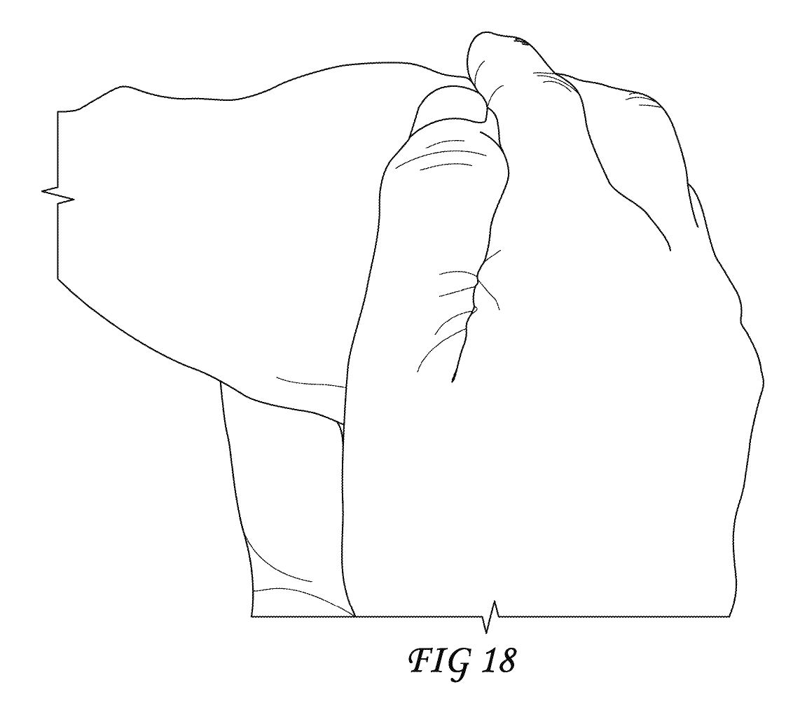

FIG. 18 shows Step Eight: Begin to glide the contact surface of their right hand back across their left hand knuckles and the finger joints on their relaxed left hand. While that is happening, the wrist and the knuckles of their right hand palm and fingers are rubbing all the fingers and knuckles of their left hand. Their thumb again covers all the knuckles beyond the wrist like their little finger did earlier.

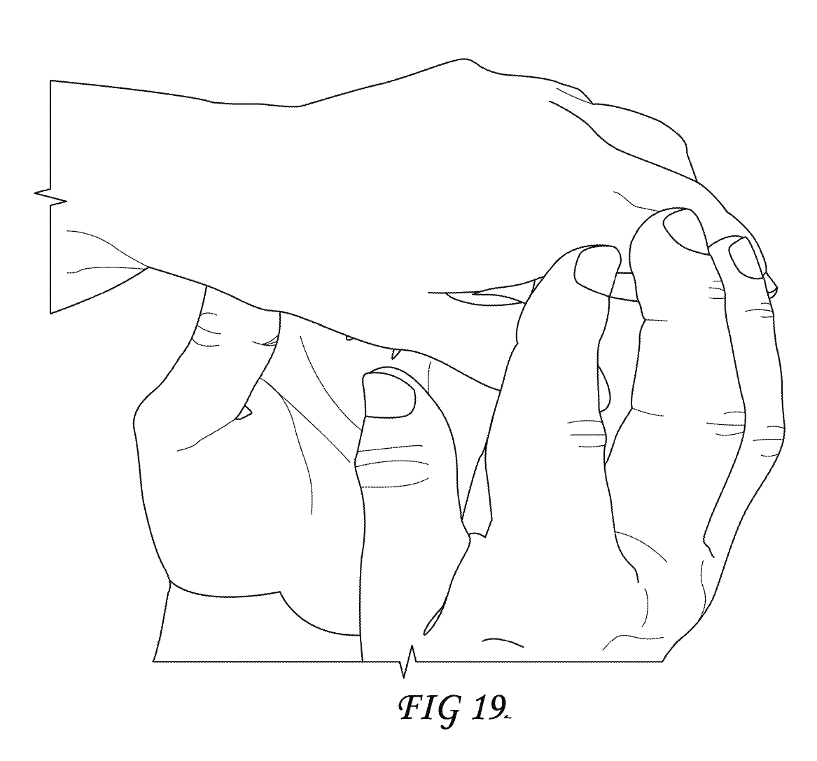

FIG. 19 shows Step Eight continued. Their right hand will come all the way until the fingertips are once more at the edge of the left hand and down from where they started. At this point they have essentially traced a path with their right hand over their left hand that resembles the shape of an oblong box as they go across, slide down, and come back across in a clockwise direction.

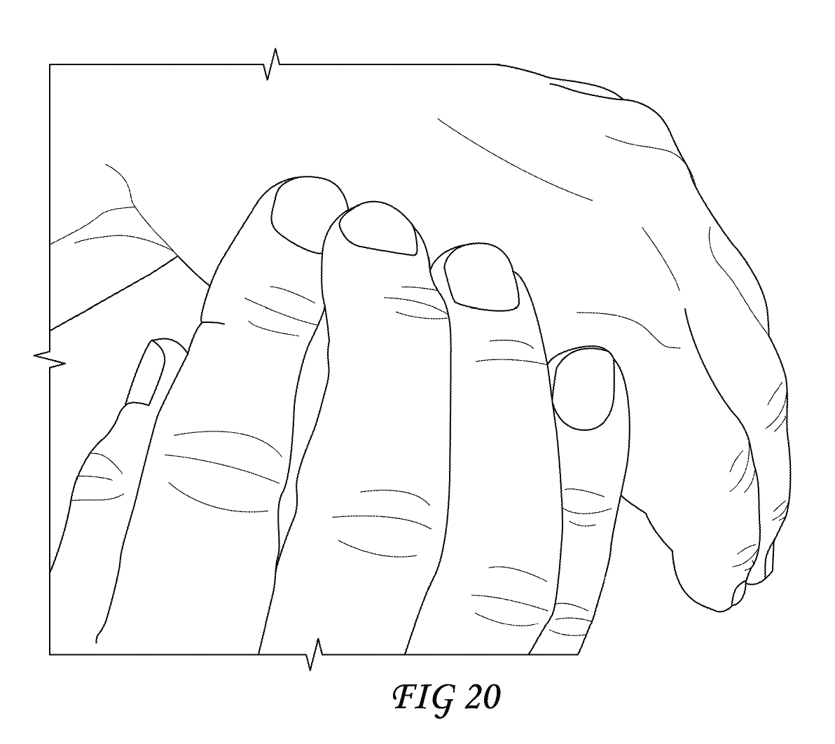

FIG. 20 shows Step Nine: Move their hand back to the starting position. Everything from here is a repeat of the steps above as they complete a total of six passes.

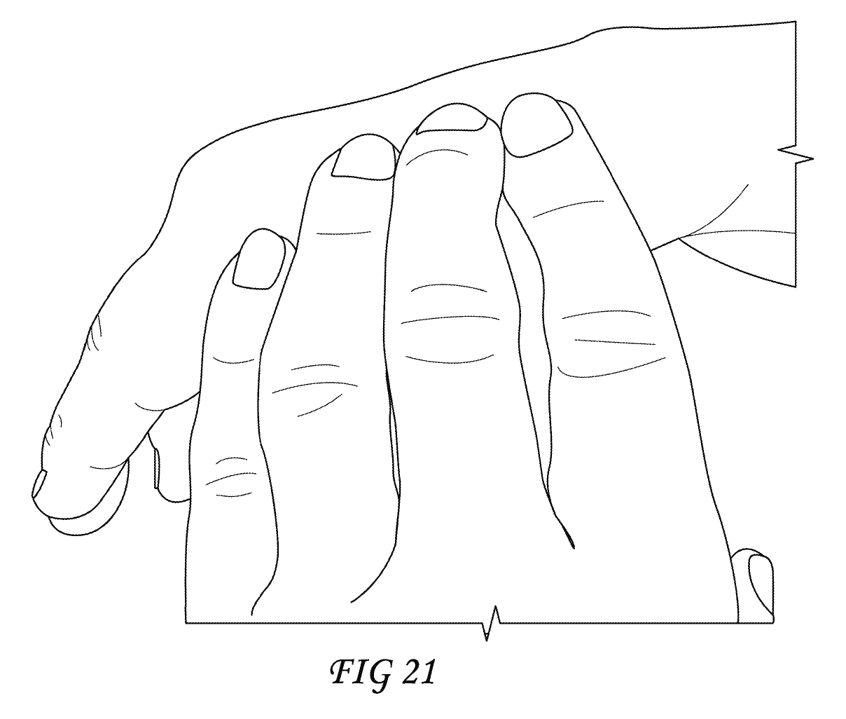

FIG. 21 shows Step Ten: Now if I put a mirror between their hands and they were ready to do the next step, they would merely repeat it on the right hand doing the reverse of their slide and glide pattern while supporting the hand on the pointed fingers and thumb of their right hand. On the left hand they went in a clockwise direction on the top of the hand making six complete patterns. On the right hand top, they will go in a counter-clockwise direction doing six more complete patterns of the the method.

It should take they thirty seconds or less to complete the process doing both hands. It is however not about the speed; it is about the contact and the feeling of making contact happen naturally and automatically.

Step Eleven: When they finish doing both hands, ask them to open their eyes and notice things around them to break their connection with the memory. Then ask, “Now check the emotions and feelings with that memory and check to see if they are neutral?” If the answer is “Yes” then they are done with that memory. If the answer is “No” then they ask them to hold in mind what they now feel and run the complete the method again on what they are now feeling.

One question they may also ask theirself is, “As they think about the feelings that are still there, do they feel like they are coming from the same memory, or is there per chance another connected memory that is now coming through?” Regardless of their answer, they do the process again on whatever comes to mind with them that is negative in nature as emotions and feelings.

It should be noted that depending on the patient, the severity of the memories that are to be neutralized, and the experience of the practitioner, the process may sometimes be more effective when five or six repetitions are done, and in some cases it is contemplated that up to 50 passes may be made.

It should be understood that while the preferred embodiments of the invention are described in some detail herein, the present disclosure is made by way of example only and that variations and changes thereto are possible and other uses have been created without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A method used on oneself of neutralizing a negative memory on yourself, comprising a right hand and a left hand, where the right hand has fingers of the right hand, a wrist area of the right hand, a Right arm, with a top side and an underside a Right Hand, with skin, a full hand, and a palm area, and a contact surface, a Fingers, including a little finger, with fingertips, a Thumb, and a Palm, with a palm area, additionally comprising a Left arm, with a top side and an underside, a Left Hand, with skin, a full hand, and a palm area, a Fingers, including a first pointer figure and a little finger, a Thumb, a Wrist area, with a back wrist area. A Knuckles, comprising a Line of knuckles, with a top knuckle and a bottom knuckle, where the method comprises the steps of placing a relaxed right hand's fingers up against a curved left hand, relaxing the right hand such that the right hand fingers make physical contact with the side of the thumb of the left hand, then slide the fingers of the right hand up, over and across the wrist area of the left hand, following the line of the knuckles, with an intention to rub and feel all the palm-to-wrist connection.

2. The method of claim 1, additionally comprising a next step of allowing both hands to feel all the contact of the palm of their right hand to the left top wrist as they slide their rubbing hand across the top of their left hand, but stop when they are just past the full back of the wrist area of the left hand and front of the palm area on their right hand.

3. The method of claim 2, additionally comprising a next step of sliding the front of their right arm down toward their fingertips until they overlay all the fingers of the left hand with their underside right arm such that their right hand palm and fingers still extend relaxed out beyond the fingers of the left hand, but stopping when their right hand is in a position where when they do pull their hand back across such that the thumb glides directly over the top of the knuckles connecting the fingers like the little finger did before.

4. The method of claim 3, additionally comprising a next step of gliding the contact surface of their right palm side back across the knuckles and joints of all the fingers and ultimately to cover the thumb of their left hand such that their palm and fingers will come all the way until the fingertips are once more at the edge of the left hand and slightly down from where they started, with an additional step of when they finish coming all the way back, slide their right hand little fingertip back to the starting position.

5. The method of claim 4, additionally comprising a next step of repeating the tracing of a path in a clockwise direction with their right hand over their left hand that resembles the shape of an oblong box as they go across, slide down, and come back across, and then move back to the starting position with four full complete passes.

6. The method of claim 5, additionally comprising a next step of switching to the second crossing path location by placing their thumb on the top of the row of knuckles such that their thumb is directly on top of that row of knuckles such that they can note that all of the other knuckles on their left hand are now completely covered by the fingers on their right, thereby allowing for the opening and use of all the energy meridians in their body.

7. The method of claim 6, additionally comprising a next step of repeating the process for a total of between four and fifty passes until they make it feel like one continuous motion, and realize, with their eyes closed, they seem to be able to do it automatically, as they notice all the feelings associated.

8. The method of claim 7, additionally comprising a next step of practicing with the left hand making a clockwise direction on the top of the hand making four to fifty complete patterns and on the right hand top, they will go in a counter-clockwise direction, with an additional step of practicing until they can do four more complete patterns almost without thinking.

9. The method of claim 8, additionally comprising a next step of FIG. 9 of beginning to slide the fingers of the left hand up, over and across the wrist area of the right hand, following the line of the knuckles, with an intention to rub and feel all the palm-to-wrist connection, while keeping their right hand still, and concurrently gliding their little finger over the complete first row of knuckles connecting their fingers, then continue doing exactly what they did on the back of their left hand with their right hand until they have completed the full process in the exact same continued pattern as they did on their left hand and come back to the starting position, followed by the step of looking at the back of the left hand they can see a solid black line outline of the area of rubbing coverage by the right hand on the back of the top left hand with the little finger of the right hand making contact with all the knuckles as they push their hand forward making sure that all an area inside the solid line are connected in contact with the fingers and palm of their right hand, followed by thinking about scaling a set of memories, where the set of memories includes all memories on a 1 to 10 with 10 being the worst, then a 1 would be a memory that is hardly there at all, then pick a memory with a negative charge in the 3 to 5 intensity range, then they think about this memory, have some fun and play it in their head so that they can learn everything they can about it by noticing the sharpness, clarity, words, sounds, and feelings.

10. The method of claim 9, additionally comprising a next step of placing their right hand fingers against their left hand where they know the little finger is in line with the top knuckles, then turning their focus as much as possible on all they recall as they repeat this memory in their mind's eye while completing four passes of Soul Link™ on each hand, followed by the stop of allowing theirself to stop thinking about what they were doing and simply look around and internally tell theirself some of the things they see. Like before, this step allows they to stop thinking about the memory they were working on.

11. A method used on another person of neutralizing a negative memory, comprising the steps of first, asking permission to touch their hand, then, asking the client to become aware of a memory they wish to neutralize, where the client does not verbalize the memory so as to keep the session content-free as much as possible.

12. The method of claim 11, comprising a next step of telling the clients that their only job is to pay attention completely to that memory while they use their hands to connect the energy fields in their body with what they are holding in mind to neutralize as the memory, and telling them to give no attention to what they are doing with their hands, only to work hard at maintaining their focus on the memory (and the emotions and feelings it brings forward).

13. The method of claim 12, comprising a next step of picking up their left arm by grasping it with their right hand and lifting it into position at the wrist with their thumb and first pointer finger, and as they lift their hand, place their left hand thumb and fingers into a pointed cone position pointed upwards directly under the center core against their left hand palm area in a support position, then placing their right hand on top of their left wrist and simply slide it to the right towards the finger tips as they say to them, “Just relax their hand and allow me to do what I do to connect all their energy while their only job is to simply focus on the memory they wish to neutralize.”

14. The method of claim 13, comprising a next step of placing their relaxed right hand little finger-tip up against their curved and relaxed left hand such that their thumb will be up against the pointer finger center knuckle to help they hold that relaxed position, such that their little finger will be aimed straight at the row of knuckles connecting the fingers on a top middle of their left hand, followed by a next step of sliding their fingers and wrist of their right hand over and rubbing against the wrist area of their left hand following the line of the knuckles connecting their fingers with an intention to rub all the feeling area of their left wrist, and simultaneously noting their little finger intentionally glides over the complete first row of big knuckles such that their right thumb will glide close to where the wrist connects to the arm, with both hands making as much skin-to-skin surface rubbing contact as possible.

15. The method of claim 14, comprising a next step of allowing the skin on the front of their right hand to feel the gliding contact of their fingers and palm on their left hand as they slide their rubbing right hand across, but stopping when they are just past their full hand and palm area, with the bottom side of their right arm resting on the top of their left hand wrist, followed by the stop of sliding the backside of their right arm down toward their left hand fingertips until they overlay all the fingers of their left hand with their underside right arm, such that their right hand palm and fingers still extend out beyond the fingers of their left hand, but stopping when their right arm is in a position where, when they pull their right hand back across, the thumb will glide directly over the top of the knuckles just beyond the wrist like the little finger did before, all the while keeping their thumb up against their fingers as they ensure both hands stay relaxed with no fingers straightened.

16. The method of claim 15, comprising a next step of beginning to glide the contact surface of their right hand back across their left hand knuckles and the finger joints on their relaxed left hand, and simultaneously moving the wrist and the knuckles of their right hand palm and fingers such that they are rubbing all the fingers and knuckles of their left hand, where their thumb again covers all the knuckles beyond the wrist like their little finger did earlier, followed by a next step of moving their right hand all the way until the fingertips are once more at the edge of the left hand and down from where they started.

17. The method of claim 16, comprising a next step of repeating the steps of claims 11 through 16 above a total of six to fifty passes.

18. The method of claim 17, comprising a next step of using the right hand top to go in a counter-clockwise direction doing six to fifty more complete patterns of the process.

19. The method of claim 18, comprising a next step of asking the client to open their eyes and notice things around them to break their connection with the memory, then asking “Now check the emotions and feelings with that memory and check to see if they are neutral?” If the answer is “Yes” then they are done with that memory; If the answer is “No” then they ask them to hold in mind what they now feel and run the complete Soul Link™ process again on what they are now feeling.

20. The method of claim 19, comprising a next step of asking “As they think about the feelings that are still there, do they feel like they are coming from the same memory, or is there per chance another connected memory that is now coming through?” Regardless of their answer, they do the process again on whatever comes to mind with them that is negative in nature as emotions and feelings.
